(19) United States
(12) Patent Application Publication
(10) Pub. No.: US 2018/0031046 A1
(43) Pub. Date: Feb. 1, 2018

(54) UNDERWATER COUPLING JOINT, AND WATER FLOW POWER GENERATOR

(71) Applicant: MITSUBISHI HEAVY INDUSTRIES, LTD., Tokyo (JP)

(72) Inventors: Akihiko UMEDA, Tokyo (JP); Shin ASANO, Tokyo (JP); Yoshitomo NODA, Tokyo (JP)

(21) Appl. No.: 15/551,104

(22) PCT Filed: Oct. 23, 2015
(86) PCT No.: PCT/JP2015/079959

§ 371 Date: Aug. 15, 2017

(30) Foreign Application Priority Data
Feb. 17, 2015 (JP) 2015-028495

(51) Int. Cl. F16D 3/18; F03B 13/10; F16J 15/52; F16D 3/84

(52) U.S. Cl. CPC F16D 3/18; F16D 3/841; F03B 13/10; F16J 15/52; F16J 3/04

(57) ABSTRACT

A coupling joint includes: joint member which has gear teeth; a center tube which has gear teeth meshing with the gear teeth, and through which a rotational force is transmitted between the joint member via the gear teeth and the gear teeth; a seal member which blocks a lubricated space including a meshing portion of the gear teeth and the gear teeth from the outside between the joint member and the center tube; a lubricant which fills the lubricated space; and a pressure-equalizing member which is provided to face a part of the lubricated space, changes the volume of the lubricated space by deforming in accordance with the pressure of the outside, and thereby equalizes the pressure of the lubricant and the pressure of the outside.

### TECHNICAL FIELD

The present invention relates to an underwater coupling joint and a water flow power generator.

Priority is claimed on Japanese Patent Application No. 2015-028495, filed on Feb. 17, 2015, the content of which is incorporated herein by reference.

### BACKGROUND ART

A water flow power generator which performs power generation by using an ocean current or a water flow in the ocean or river includes an impeller and a power generator. The impeller has a plurality of blades which extend toward an outer circumferential side. An end portion of a rotational shaft is linked to the impeller, the rotational shaft rotates together with the impeller that rotates by the ocean current or the water flow, and thereby the power generator performs power generation.

In the water, a large force generated by the ocean current or the water flow acts on the blades of the impeller. Then, a force or a moment in an axial direction or in a radial direction acts on the rotational shaft linked to the center of the impeller.

In order to increase power generation efficiency, a method of increasing a diameter of the impeller, that is, a length of the blades, is employed. However, the force or the moment which acts on the rotational shaft from the impeller substantially increases.

In order to prevent an influence caused by the above-described force or moment on the power generator from the impeller, there is a case where a coupling device described in Patent Document 1, for example, is used between the impeller and the rotational shaft of the power generator. The coupling device performs transmission of the rotational force between the impeller and the rotational shaft of the power generator while allowing a phase displacement in the axial direction, in the radial direction, and in the inclining direction of a side close to the impeller and a side close to the power generator.

In the coupling device, since a gear is used in transmission of the rotational force, a lubricant for suppressing wear becomes necessary in a meshing portion of the gears.

The coupling device described in Patent Document 1 includes a seal member in order to prevent a fluid having a high pressure from entering from the outside.

### CITATION LIST

### Patent Literature

[Patent Document 1] Japanese Unexamined Patent Application, First Publication No. 2011-21619

### SUMMARY OF INVENTION

### Technical Problem

In a case where an underwater power generator is installed being sunk deep in the sea, a high water pressure, for example, 30 atmospheric pressure (approximately 3 MPa) acts. Therefore, there is a possibility that the seawater flows into the underwater power generator from the outside through a seal portion by a seal member. In this case, there is a possibility that the lubricant of a meshing portion of the gear flows out. When the lubricant flows out, the gear is damaged due to an increase in friction of the meshing portion, and there is a possibility that the underwater power generator cannot be used.

Meanwhile, in order to maintain sealing properties in the seal portion, a method of periodically performing exchange of the seal member or supply of the lubricant is considered. However, in this case, a load applied to maintenance increases. Furthermore, marine pollution caused by an outflow of the lubricant is also concerned.

An object of the present invention is to provide an underwater coupling joint which can suppress a load applied to maintenance, and a water flow power generator.

### Solution to Problem

According to one aspect of the present invention, an underwater coupling joint includes a first shaft member which has first gear teeth. The underwater coupling joint further includes a second shaft member which has second gear teeth meshing with the first gear teeth, and through which a rotational force is transmitted between the first shaft members via the first gear teeth and the second gear teeth. The underwater coupling joint further includes a seal member which blocks a space including a meshing portion of the first gear teeth and the second gear teeth from the outside between the first shaft members and the second shaft member. The underwater coupling joint further includes a lubricant which fills the space. The underwater coupling joint further includes a pressure-equalizing mechanism which is provided to face a part of the space, changes the volume of the space by deforming in accordance with a pressure of the outside, and thereby equalizes the pressure of the lubricant and the pressure of the outside.

In this configuration, when the underwater coupling joint is sunk in the water, it is possible to deform the pressure-equalizing mechanism in accordance with the pressure of the outside, that is, the periphery of the underwater coupling joint.

By the deformation of the pressure-equalizing mechanism, it is possible to equalize the pressure of the lubricant in the space and the pressure of the outside by changing a volume of the space filled with the lubricant. Accordingly, it is possible to suppress generation of a large difference in pressure between the seal member and each of the first shaft member and the second shaft member. As a result, it is possible to suppress infiltration of water from the outside into the space filled with the lubricant, or leakage of the lubricant to the outside from the space.

According to a second aspect of the invention, in the underwater coupling joint, the pressure-equalizing mechanism may be bellows of which a first end portion is open, the other end portion has a blocked tubular shape, and the first end portion and the other end portion are capable of extending and contracting in a direction of being in contact with and separated from each other.

By using such bellows, it is possible to make the pressure of the outside act on the other blocked end. Accordingly, it is possible to shorten the bellows in a direction in which the other end approaches the opened first end portion. Furthermore, it is possible to extend the bellows in a direction in which the other end side is separated from the first end portion. Accordingly, the volume of the space changes, and it is possible to equalize each pressure of the water of the outside and the lubricant in the space.

According to a third aspect of the invention, in the underwater coupling joint, the bellows in the second aspect may have a spiral groove on an inner circumferential surface.

In this configuration, when filling the inside of the space with the lubricant, by rotating the bellows around a center shaft, it is possible to move bubbles that remain on the inner side of the groove along the spiral groove. Therefore, it is possible to discharge the bubbles that remain on the inner side of the groove from the first end portion of the opened bellows.

According to a fourth aspect of the invention, in the underwater coupling joint, in any aspect of the first to third aspects, an external pressure introduction portion which introduces the pressure of the outside to the inside of one of the first shaft member and the second shaft member may be provided, and the external pressure introduction portion may include the pressure-equalizing mechanism.

In this configuration, it is possible to make the pressure of the outside act on the pressure-equalizing mechanism via the external pressure introduction portion. Therefore, it is possible to equalize the pressure of the water of the outside and the lubricant in the space.

By providing the external pressure introduction portion on the inside of one of the first shaft member and the second shaft member, it is possible to achieve efficient use of the space. Furthermore, by providing the pressure-equalizing mechanism in the external pressure introduction portion, the pressure-equalizing mechanism is not exposed to the outside, and it is possible to suppress damage of the pressure-equalizing mechanism by unexpected contact or the like.

According to a fifth aspect of the invention, in the underwater coupling joint, in any aspect of the first to third aspects, an injection port through which the lubricant is injected from the outside into the space may be provided in one of the first shaft member and the second shaft member, and the injection port may include the pressure-equalizing mechanism.

In this configuration, when the pressure-equalizing mechanism is provided in the injection port of the lubricant, the pressure of the outside acts on the pressure-equalizing mechanism via the injection port, and it is possible to achieve equalization of the pressure of the water of the outside and the lubricant in the space. Accordingly, it is not necessary to additionally provide a part for providing the pressure-equalizing mechanism.

According to a sixth aspect of the invention, in the underwater coupling joint, in any aspect of the first to third aspects, the seal member may be formed to be deformable in accordance with the pressure of the outside, and may also function as the pressure-equalizing mechanism.

In this manner, as the seal member functions as the pressure-equalizing mechanism, it is possible to reduce the number of components.

According to a seventh aspect of the invention, in the underwater coupling joint, in any aspect of the first to sixth aspects, the seal member may be bonded to the first shaft member and the second shaft member.

In this manner, by bonding the seal member to the first shaft member and the second shaft member, it is possible to suppress infiltration of water from the outside into the space filled with the lubricant, or leakage of the lubricant to the outside from the space.

According to an eighth aspect of the invention, a water flow power generator includes: an impeller having a plurality of blades; a power generator which is driven by the impeller; and the above-described underwater coupling joint which links a rotational shaft of the impeller and an input shaft of the power generator.

In this configuration, in the underwater coupling joint, it is possible to suppress infiltration of water from the outside into the space filled with the lubricant, or leakage of the lubricant to the outside from the space.

### Advantageous Effects of Invention

According to the above-described underwater coupling joint and the water flow power generator, it is possible to maintain a lubricated state in the underwater coupling joint, and to suppress a load applied to maintenance.

### BRIEF DESCRIPTION OF DRAWINGS

FIG. 1 is a perspective view showing a water flow power generator according to an embodiment of the invention.

FIG. 2 is a sectional view showing a configuration of a linking part between an impeller and a nacelle in the embodiment of the water flow power generator.

FIG. 3 is a sectional view showing a configuration of an underwater coupling joint in a first embodiment of the invention.

FIG. 4 is a sectional view showing a configuration of an underwater coupling joint in a second embodiment of the invention.

FIG. 5 is a sectional view showing a configuration of an underwater coupling joint in a third embodiment of the invention.

FIG. 6 is a sectional view showing a configuration of an underwater coupling joint in a fourth embodiment of the invention.

FIG. 7 is a sectional view showing a modification example of a seal member provided in the underwater coupling joint.

FIG. 8 is a sectional view showing a modification example in which the seal member and bellows of a pressure-equalizing member have a spiral shape.

FIG. 9 is a sectional view showing a modification example in which a meshing portion has a tapered shape.

### DESCRIPTION OF EMBODIMENTS

### First Embodiment

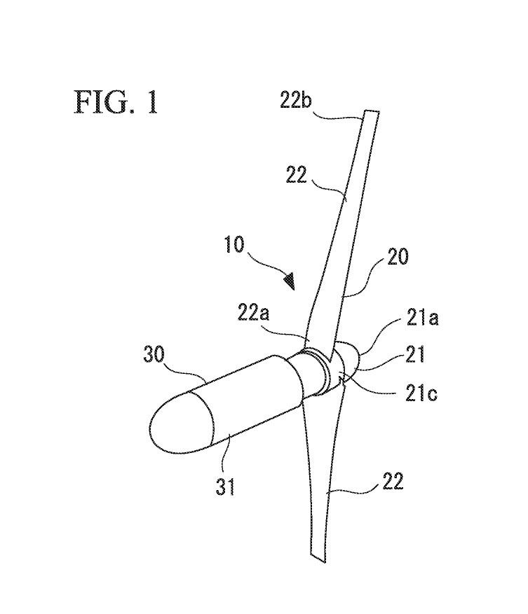

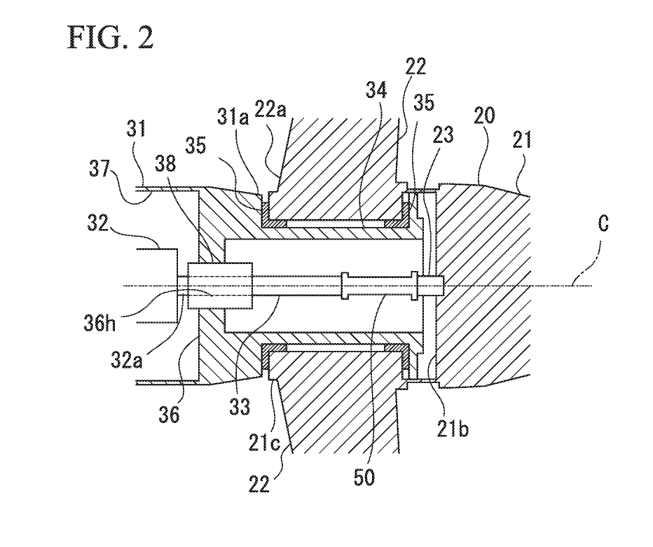

FIG. 1 is a perspective view showing a water flow power generator according to an embodiment. FIG. 2 is a sectional view showing a configuration of a linking part between an impeller and a nacelle in the embodiment of the water flow power generator.

As shown in FIG. 1, a water flow power generator 10 in the embodiment is installed in the deep seawater by being moored via an anchor line (not shown), on the seabed or in an underwater structure.

The water flow power generator 10 includes an impeller 20 and a nacelle 30.

The impeller 20 includes a hub 21 and a blade 22.

As shown in FIGS. 1 and 2, the hub 21 is disposed in a center portion of the impeller 20. The hub 21 is formed in a so-called shell shape of which an outer diameter gradually decreases toward a tip end 21a. The hub 21 has an end surface 21b on a side opposite to the tip end 21a. The end surface 21b is orthogonal to a rotation center shaft C (hereinafter, simply referred to as a shaft line C) of the impeller 20. In an outer circumferential portion of the end surface 21b of the hub 21, a tubular portion 21c is integrally provided. The tubular portion 21c is formed in a cylindrical shape which extends toward the side opposite to the tip end 21a in a direction (hereinafter, simply referred to as a shaft line C direction) in which the shaft line C extends. On the end surface 21b of the hub 21, a shaft (rotational shaft) 23 is integrally attached. The shaft 23 protrudes toward the side opposite to the tip end 21a in the shaft line C direction.

A plurality of the blades 22 are provided at an interval in the circumferential direction in the outer circumferential portion of the hub 21.

In the embodiment, two blades 22 are provided. The two blades 22 are disposed at positions which are rotationally symmetric to each other. In each of the blades 22, a base end portion 22a is integrally fixed to the tubular portion 21c of the hub 21. Each of the blades 22 extends outward in a radiation direction from the hub 21 toward a tip end portion 22b thereof.

The nacelle 30 includes a casing 31, a power generator 32, and a main shaft 33.

The casing 31 is formed in a cylindrical shape which extends in the shaft line C direction. In the casing 31, an impeller support portion 34 is provided in a first end portion 31a thereof The impeller support portion 34 supports the impeller 20 to be freely rotatable. On the outer circumferential surface of the impeller support portion 34, one pair of external bearings 35 is provided at an interval in the shaft line C direction. The impeller 20 is supported by the impeller support portion 34 to be freely rotatable via the external bearings 35. Each of the external bearings 35 is formed of, for example, a resin, and functions as a so-called slide bearing which supports the impeller 20 considering the seawater on the periphery as a lubricant.

In the casing 31, a partition wall 36 is provided. The partition wall 36 has a plane which is orthogonal to the shaft line C and is oriented toward the side (hereinafter, simply referred to as a second end portion side) opposite to the first end portion 31a in the shaft line C direction. In the casing 31, a tightly-closed power generator chamber 37 is formed further on the second end portion side than the partition wall 36 in the shaft line C direction. The inside of the power generator chamber 37 is an air atmosphere. In the power generator chamber 37, the power generator 32 is stored.

The power generator 32 includes an input shaft 32a. The input shaft 32a protrudes to the side close to the partition wall 36 along the shaft line C. The power generator 32 includes a rotor (not shown) provided to be integrated with the input shaft 32a, and a stator (not shown) which opposes the rotor. The power generator 32 generates power as the rotor rotates relatively to the stator together with the input shaft 32a. The power generated by the power generator 32 is supplied to the outside via a power-transmission line (not shown).

A main shaft 33 is linked to the input shaft 32a of the power generator 32 via a speed increaser (not shown) and a brake (not shown).

The main shaft 33 extends in the impeller support portion 34 through a shaft hole 36h formed in the partition wall 36. A ring-like seal member 38 is provided between the main shaft 33 and the shaft hole 36h. The seal member 38 prevents infiltration of water into the power generator chamber 37 from the periphery of the main shaft 33.

A coupling joint (underwater coupling joint) 50 is provided between the main shaft 33 and the shaft 23 provided in the hub 21 of the impeller 20. The main shaft 33 and the shaft 23 are connected to each other via the coupling joint 50.

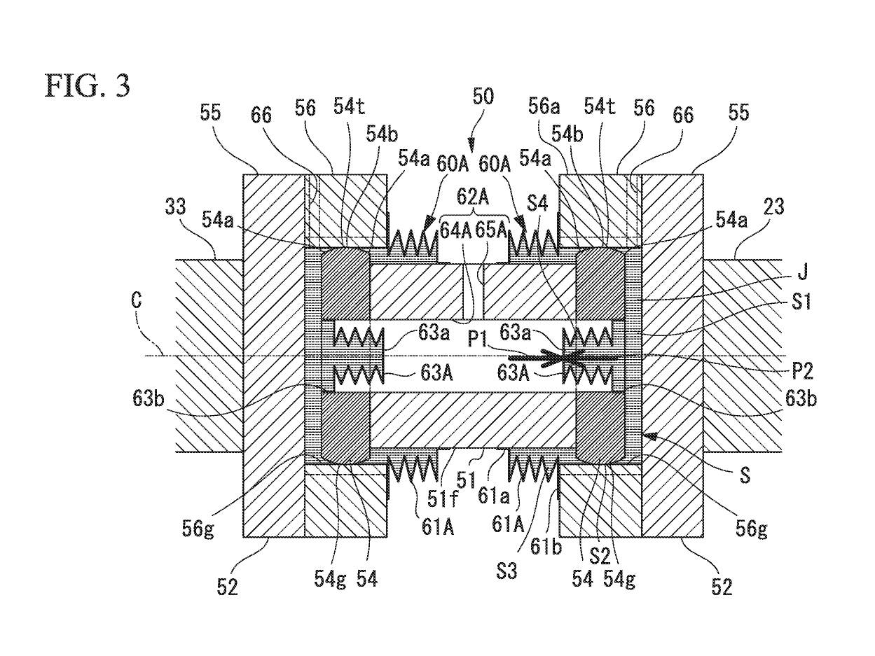

FIG. 3 is a sectional view showing a configuration of the underwater coupling joint in a first embodiment.

As shown in FIG. 3, the coupling joint 50 includes a center tube (second shaft member) 51, a joint member (first shaft member) 52, and a seal portion 60A. The joint members 52 are respectively provided at both ends of the center tube 51.

The center tube 51 is formed in a tubular shape. In both end portions of the center tube 51, inner gears 54 are integrally provided. The inner gears 54 are formed in a continuous annular shape along the outer circumferential surface of the center tube 51. The inner gear 54 includes gear teeth (second gear teeth) 54g in the outer circumferential portion thereof Here, in the gear teeth 54g, the shape of the section of gear surface 54t formed in the outer circumferential portion is curved in a projected shape such that a center portion 54b is swollen toward the outer circumferential side with respect to both end portions 54a in the gear width direction along the shaft line C.

The joint member 52 integrally includes two disk-like joint plates 55 and two tubular outer sleeves 56.

One of the two joint plates 55 is integrally linked to the main shaft 33. The other one of the two joint plates 55 is integrally linked to the shaft 23.

The outer sleeve 56 is provided to be integrated with each of the joint plates 55. The outer sleeve 56 is provided on a surface side which opposes the center tube 51 of the joint plate 55. On the inner circumferential sides of the outer sleeves 56, the inner gear 54 of the center tube 51 is disposed. The outer sleeve 56 has gear teeth (first gear teeth) 56g having a shape of spur teeth which meshes with the gear teeth 54g of the inner gear 54.

The joint member 52 can be relatively displaced in the shaft line C direction with respect to the center tube 51 as the gear teeth 54g curved in a projected shape and the gear teeth 56g having a shape of spur teeth mesh with each other. The joint members 52 can be displaced in a direction of being inclined to each other with respect to the shaft line C as the gear teeth 54g and the gear teeth 56g mesh with each other.

In other words, the impeller 20 having the shaft 23 is allowed to be displaced relative to the shaft line C direction with respect to the main shaft 33, and to be inclined to each other.

The joint members 52 are respectively linked to the gear teeth 54g of both ends of the center tube 51. Therefore, the shaft 23 is allowed to be eccentric to the main shaft 33 in the radial direction while maintaining a state where the center shaft of one joint member 52 is parallel to the center shaft of the other joint member 52.

The seal portions 60A respectively include a seal member 61A, an external pressure introduction portion 62A, and a pressure-equalizing member (pressure-equalizing mechanism) 63A.

The seal member 61A blocks a space between an outer circumferential surface 51f of the center tube 51 and the outer sleeves 56 positioned on the outer circumferential sides of both end portions of the center tube 51, while maintaining water-tightness. The seal member 61A is formed in a shape of bellows that can extend and contract in the shaft line C direction. The seal member 61A is made of metal. A first end portion 61a of the seal member 61A is bonded to the outer circumferential surface 51f of the center tube 51 by seal welding or friction bonding. Similarly, a second end portion 61b of the seal member 61A is bonded to the outer sleeve 56 by seal welding or friction bonding. The seal members 61A can be deformed in accordance with the relative displacement in the shaft direction, in the radial direction, and in the inclining direction of the shaft 23 with respect to the main shaft 33, and can maintain the sealed state.

The external pressure introduction portion 62A includes a seawater introduction portion 64A and an introduction hole 65A.

The seawater introduction portion 64A is a columnar passage which extends along the center shaft of the external pressure introduction portion 62A.

The introduction hole 65A is formed to penetrate the seawater introduction portion 64A in the thickness direction thereof.

The outside of the center tube 51 and the seawater introduction portion 64A communicate with each other by the introduction hole 65A. Accordingly, in a state where the water flow power generator 10 is sunk in the water, the seawater flows into the seawater introduction portion 64A via the introduction hole 65A.

The pressure-equalizing member 63A is made of metal and is formed in a shape of bellows. In the pressure-equalizing member 63A, a first end portion 63a is blocked and a second end portion 63b is open. The pressure-equalizing members 63A are respectively disposed in both end portions of the seawater introduction portion 64A in the shaft line C direction. The second end portion 63b of the pressure-equalizing member 63A is fitted to each other to block both end portions of the seawater introduction portion 64A. The first end portion 63a of the pressure-equalizing member 63A is a flat surface which is orthogonal to the center shaft of the center tube 51.

The outer sleeve 56 of the joint member 52 includes two injection ports 66 which allow an outer circumferential surface 56a and an inner circumferential surface 56b to communicate with each other. For example, when assembling the water flow power generator 10, lubricant J is injected through the injection port 66 and fills a void S1 formed by the joint plate 55, the outer sleeve 56, and the inner gear 54 of the joint member 52, from the side close to the outer circumferential surface 56a of the outer sleeve 56. The void S1 communicates with a space S3 in the seal member 61A through a meshing portion S2 of the gear teeth 54g and the gear teeth 56g. The void S1 communicates with a space S4 in the pressure-equalizing member 63A. A lubricated space (space) S is configured of the void S1, the meshing portion S2, the space S3, and the space S4. The lubricant J fills the lubricated space S. The injection port 66 is blocked by mounting a cap (not shown), welding or the like after filling the inside with the lubricant J.

In the seal portion 60A having such a configuration, when the nacelle 30 of the water flow power generator 10 is sunk in the water, the seawater flows into the seawater introduction portion 64A from the introduction hole 65A. Then, a pressure P1 of the seawater in the seawater introduction portion 64A acts on the first end portion 63a of the pressure-equalizing member 63A. The pressure-equalizing member 63A extends and contracts in the direction in which the first end portion 63a approaches and is separated from the second end portion 63b such that the pressure P1 of the seawater that acts on the first end portion 63a and a pressure P2 of the lubricant J of the space S4 in the pressure-equalizing member 63A are balanced. For example, when an underwater depth of the nacelle 30 increases and the pressure P1 of the seawater becomes higher than the pressure P2 of the lubricant J, the pressure-equalizing member 63A having a shape of bellows contracts such that the first end portion 63a approaches the second end portion 63b. Accordingly, the pressure PI of the seawater on the periphery of the nacelle 30 and the pressure P2 of the lubricant J that fills the lubricated space S become equalized.

According to the above-described first embodiment, when the coupling joint 50 is sunk in the water, the pressure-equalizing member 63A is deformed in accordance with the pressure that acts from the seawater. Therefore, it is possible to equalize the pressure of the lubricated space S and the pressure of the outside. Accordingly, it is possible to suppress the action of the large pressure from the outside on the seal member 61A. Therefore, it is possible to suppress infiltration of water from the outside into the lubricated space S filled with the lubricant J, or leakage of the lubricant J to the outside from the lubricated space S.

As a result, it is possible to maintain the lubricated state in the coupling joint 50, and to suppress a load applied to the maintenance.

Furthermore, by providing the external pressure introduction portion 62A on the inside of the center tube 51, it is possible to achieve an efficient use of the space. By providing the pressure-equalizing member 63A in the external pressure introduction portion 62A, it is possible to suppress damage of the pressure-equalizing member 63A caused by unexpected contact or the like without exposing the pressure-equalizing member 63A to the outside.

Furthermore, since the pressure-equalizing member 63A is made of metal, it is possible to easily ensure sufficient strength. Accordingly, it is possible to suppress damage of the pressure-equalizing member 63A caused by the high pressure P1 of the seawater.

Furthermore, since the pressure-equalizing member 63A has a shape of bellows, it is possible to increase a fluctuation amount of a volume of the space S4 on the inside as the first end portion 63a approaches and is separated from the second end portion 63b.

Accordingly, in a case where an installation depth of the water flow power generator 10 is deep, it is possible to contract the pressure-equalizing member 63A in accordance with the pressure P1 of the seawater that increases in accordance with the underwater depth. Accordingly, it is possible to easily achieve equalization with the pressure P2 of the lubricant J. Therefore, compared to a case of sealing by an O-ring or the like, it is possible to ensure a larger adjustment margin.

Furthermore, since the seal member 61A is bonded to the outer sleeve 56 and the center tube 51, it is possible to reduce infiltration of water from the outside into the lubricated space S filled with the lubricant J, or leakage of the lubricant J to the outside from the lubricated space S.

### Second Embodiment

Next, the underwater coupling joint and the water flow power generator in a second embodiment of the invention will be described based on the drawings. Since the second embodiment is different from the first embodiment only in a configuration of an external pressure introduction portion 62B and a pressure-equalizing member 63B, the same parts as those of the first embodiment will be given the same reference numerals, and overlapping descriptions will be omitted.

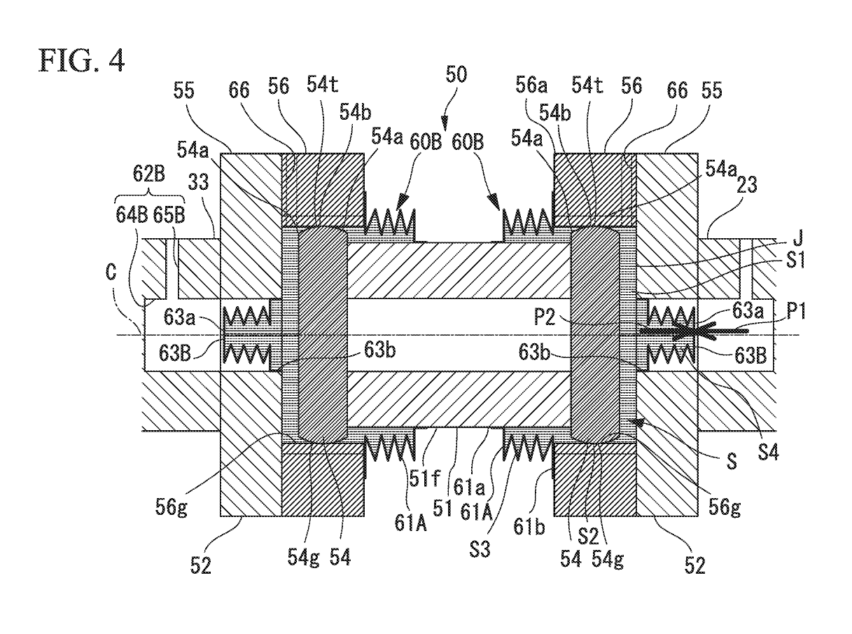

FIG. 4 is a sectional view showing a configuration of the underwater coupling joint in a second embodiment of the invention.

As shown in FIG. 4, the coupling joint 50 in the embodiment includes the center tube 51, the joint member 52, and a seal portion 60B.

The seal portion 60B includes the seal member 61A, the external pressure introduction portion 62B, and the pressure-equalizing member (pressure-equalizing mechanism) 63B.

The seal member 61A blocks a space between the outer circumferential surface 51f of the center tube 51 and the outer sleeves 56 positioned on the outer circumferential sides of both end portions of the center tube 51, while maintaining water-tightness.

The external pressure introduction portion 62B includes a seawater introduction portion 64B and an introduction hole 65B.

The seawater introduction portions 64B are respectively formed to be continuous in the shaft line C direction across the joint plates 55 on both sides of the coupling joint 50 and the main shaft 33 bonded to each of the joint plates 55 and the shaft 23.

The introduction holes 65B are respectively formed to penetrate the main shaft 33 and the shaft 23. The main shaft 33, the outside of the shaft 23, and the seawater introduction portion 64B communicate with each other by the introduction hole 65B.

The pressure-equalizing member 63B is formed in a shape of metal bellows. In the pressure-equalizing member 63B, the first end portion 63a side is blocked and the second end portion 63b side is open. The pressure-equalizing member 63B is provided in the end portion of the seawater introduction portion 64B while the second end portion 63b faces the void S1.

In the seal portion 60B having such a configuration, when the nacelle 30 of the water flow power generator 10 is sunk in the water, the seawater flows into the seawater introduction portion 64B from the introduction hole 65B. Then, the pressure of the seawater in the seawater introduction portion 64B acts on the first end portion 63a of the pressure-equalizing member 63B. When the underwater depth of the nacelle 30 increases and the pressure P1 of the seawater becomes higher than the pressure P2 of the lubricant J, the pressure-equalizing member 63B having a shape of bellows contracts in the direction in which the first end portion 63a approaches the second end portion 63b. Accordingly, the pressure P1 of the seawater on the periphery of the nacelle 30 and the pressure P2 of the lubricant J that fills the lubricated space S become equalized.

According to the above-described second embodiment, the pressure of the outside acts on the pressure-equalizing member 63B as the water of the outside is introduced into the external pressure introduction portion 62B. Therefore, it is possible to equalize the pressure of the water of the outside and the lubricant J in the lubricated space S.

Accordingly, it is possible to suppress the action of the large pressure from the outside on the seal member 61A. Therefore, it is possible to suppress infiltration of water from the outside into the lubricated space S filled with the lubricant J, or leakage of the lubricant J to the outside from the lubricated space S.

As a result, it is possible to maintain the lubricated state in the coupling joint 50, and to suppress a load applied to the maintenance.

Furthermore, by providing the external pressure introduction portions 62B respectively on the inside of the joint member 52, the main shaft 33, and the shaft 23, it is possible to achieve an efficient use of the space.

Furthermore, by providing the pressure-equalizing member 63B in the external pressure introduction portion 62B, it is possible to suppress damage of the pressure-equalizing member 63A caused by unexpected contact or the like without exposing the pressure-equalizing member 63B to the outside.

### Third Embodiment

Next, a third embodiment of the underwater coupling joint and the water flow power generator according to the invention will be described. The third embodiment is different from the first embodiment only in a configuration of an external pressure introduction portion 62C and a pressure-equalizing member 63C. Therefore, the same parts as those of the first and second embodiments will be given the same reference numerals, and overlapping descriptions will be omitted.

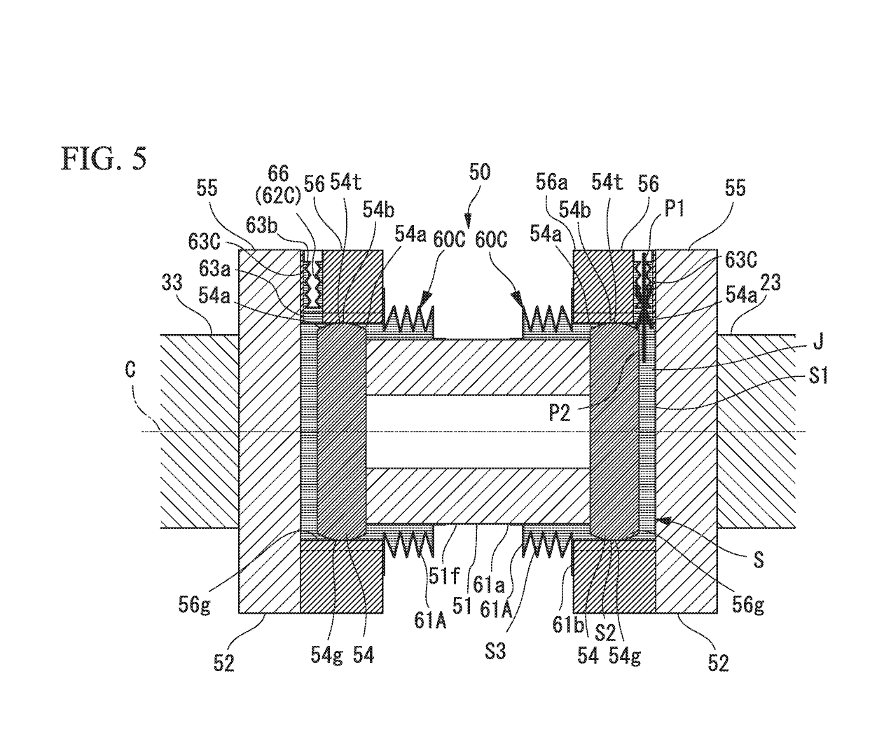

FIG. 5 is a sectional view showing a configuration of the underwater coupling joint in the third embodiment of the invention.

As shown in FIG. 5, the coupling joint 50 in the embodiment includes the center tube 51, the joint member 52, and a seal portion 60C.

The seal portion 60C includes the seal member 61A, the external pressure introduction portion 62C, and the pressure-equalizing member (pressure-equalizing mechanism) 63C.

The seal member 61A blocks a space between the outer circumferential surface 51f of the center tube 51 and the outer sleeves 56 positioned on the outer circumferential sides of both end portions of the center tube 51, while maintaining water-tightness.

The external pressure introduction portion 62C in the embodiment functions as the injection port 66 formed for injecting the lubricant J into the lubricated space S. The injection port 66 is formed in the outer sleeve 56 of the joint member 52.

The pressure-equalizing member 63C is formed in a shape of bellows. The pressure-equalizing member 63C is formed of metal. In the pressure-equalizing member 63C, the first end portion 63a side is blocked and the second end portion 63b side is open. The pressure-equalizing member 63C is provided in the injection port 66. The pressure-equalizing member 63C is provided such that the opened second end portion 63b is oriented toward the outer circumferential side of the outer sleeve 56. The pressure-equalizing member 63C also functions as a cap that blocks the injection port 66 after the injection of the lubricant J.

In the seal portion 60C having such a configuration, when the nacelle 30 of the water flow power generator 10 is sunk in the water, the seawater flows into the injection port 66 which is the external pressure introduction portion 62C. Then, the pressure of the seawater in the seawater introduction portion 64C acts on the first end portion 63a of the pressure-equalizing member 63C. When the underwater depth of the nacelle 30 increases and the pressure P1 of the seawater becomes higher than the pressure P2 of the lubricant J, the pressure-equalizing member 63C having a shape of bellows extends in the direction in which the first end portion 63a is separated from the second end portion 63b. Accordingly, the pressure P1 of the seawater on the periphery of the nacelle 30 and the pressure P2 of the lubricant J that fills the lubricated space S become equalized.

According to the above-described third embodiment, when the coupling joint 50 is sunk in the water, the pressure-equalizing member 63C is deformed in accordance with the pressure P1 of the seawater. Accordingly, the pressure of the lubricant J in the lubricated space S and the pressure of the outside are equalized. Therefore, it is possible to suppress the action of the high pressure from the outside on the seal member 61A. Accordingly, it is possible to suppress infiltration of water from the outside into the lubricated space S filled with the lubricant J, or leakage of the lubricant J to the outside from the lubricated space S.

As a result, it is possible to maintain the lubricated state in the coupling joint 50, and to suppress a load applied to the maintenance.

Furthermore, as the pressure-equalizing member 63C is provided with the injection port 66 of the lubricant J, it is not necessary to additionally provide a part for providing the pressure-equalizing member 63C. In other words, similar to the configurations of the above-described first and second embodiments, it is not necessary to form the introduction holes 65A and 65B and the seawater introduction portion 64A and 64B. Furthermore, the pressure-equalizing member 63C functions as a cap that blocks the injection port 66.

As a result, it is possible to reduce the number of components that configure the seal portion 60C, and to further reduce a possibility of leakage by reducing the number of locations having a possibility of generation of leakage.

In the above-described first to third embodiments, the seal member 61A has a shape of bellows that can extend and contract. However, the seal member 61A may be replaced with other seal members, such as an O-ring.

### Fourth Embodiment

Next, a fourth embodiment of the underwater coupling joint and the water flow power generator according to the invention will be described. In the fourth embodiment which will be described hereinafter, the same parts as those of the first to third embodiments will be given the same reference numerals, and overlapping descriptions will be omitted.

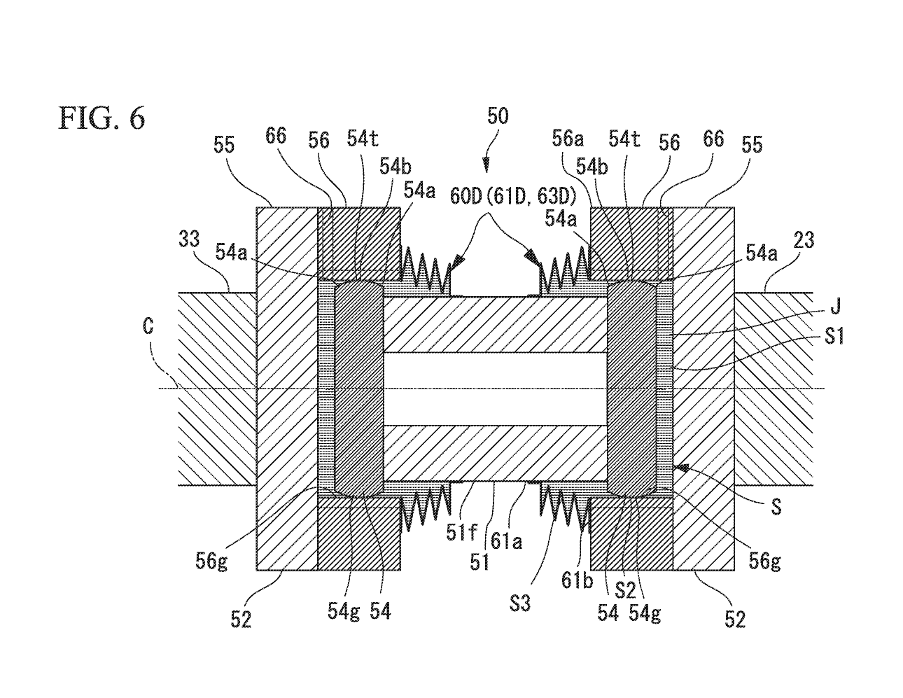

FIG. 6 is a sectional view showing a configuration of the underwater coupling joint in the fourth embodiment of the invention.

As shown in FIG. 6, the coupling joint 50 in the embodiment includes the center tube 51, the joint member 52, and a seal portion 60D.

The seal portion 60D includes a seal member 61D.

The seal members 61D are formed in a shape of bellows that can extend and contract in the shaft line C direction. The seal members 61D are made of metal and block a space between the outer circumferential surface 51f of the center tube 51 and the outer sleeves 56 positioned on the outer circumferential sides of both end portions of the center tube 51, while maintaining water-tightness.

The seal members 61D are formed in a tapered shape in which the outer diameter gradually increases as approaching the outer sleeve 56. In the seal member 61D formed in a tapered shape in this manner, the pressure P1 of the seawater also acts in the shaft direction of the center tube 51.

In the embodiment, the seal member 61D functions as a pressure-equalizing member 63D (pressure-equalizing mechanism). In other words, when the nacelle 30 of the water flow power generator 10 is sunk in the water, the seal member 61D is slightly pressed in the shaft direction by the pressure P1 of the seawater that acts on the seal member 61D, and for example, contracts in the direction in which the first end portion 61a approaches the second end portion 61b. Accordingly, the pressure P1 of the seawater on the periphery of the nacelle 30 and the pressure P2 of the lubricant J in a lubricated space S5 in the seal member 61D become equalized.

According to the above-described fourth embodiment, the seal member 61D can be deformed in accordance with the pressure of the outside, and functions as the pressure-equalizing member 63D.

Accordingly, similar to the configuration described in the above-described first and second embodiments, it is not necessary to form the introduction holes 65A and 65B and the seawater introduction portions 64A and 64B, or to provide the pressure-equalizing members 63A to 63C.

As a result, it is possible to reduce the number of components that configure the seal portion 60D. Furthermore, it is possible to further reduce a possibility of leakage by reducing the number of locations having a possibility of leakage.

Similar to the above-described first embodiment, when the coupling joint 50 is sunk in the water, the seal member 61D is deformed in accordance with the pressure P1 of the seawater. Therefore, it is possible to equalize the pressure P2 of the lubricant J in the lubricated space S and the pressure P1 of the outside. Accordingly, it is possible to suppress the action of the high pressure from the outside on the seal member 61D. As a result, it is possible to suppress infiltration of water from the outside into the lubricated space S filled with the lubricant J, or leakage of the lubricant J to the outside from the lubricated space S.

In the above-described fourth embodiment, the seal member 61D has a shape of bellows, but the shape thereof is not limited thereto. When the volume on the inner side of the seal member 61D changes in accordance with the pressure PI of the seawater, any configuration may be used.

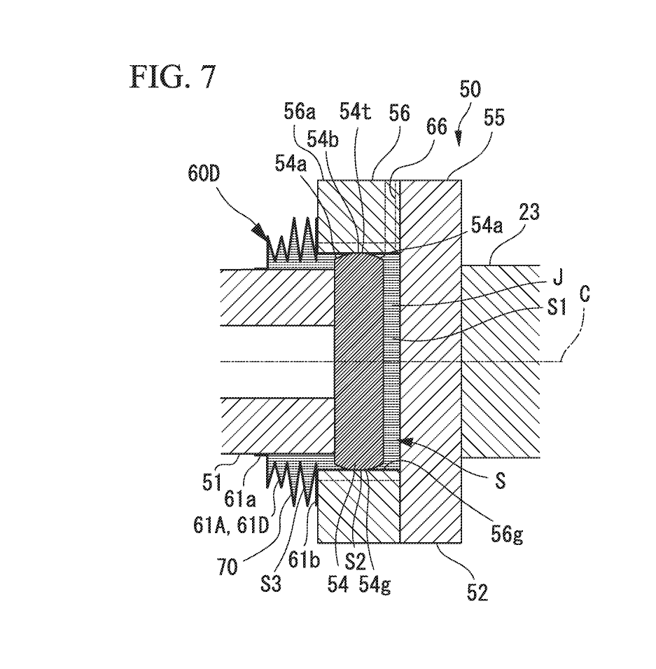

For example, as shown in FIG. 7, the outer diameter of the bellows-like seal member 61D may be gradually enlarged in the direction in which the pressure P1 of the seawater acts, and a pressure receiving surface 70 which receives the pressure P1 of the seawater may be provided.

By the configuration, it is possible to efficiently perform extension and contraction deformation of the seal member 61D by the pressure P1 of the seawater. In this manner, the configuration in which the outer diameter is gradually enlarged can also be similarly employed in the pressure-equalizing members 63A to 63C.

### Other Modification Examples

The invention is not limited to the above-described embodiments, and includes embodiments obtained by adding various changes into the above-described embodiments within a scope that does not depart from spirit of the invention. In other words, specific shapes or configurations described in the embodiments are merely examples, and can be appropriately changed.

In the first to third embodiments, the bellows-like seal member 61A and the pressure-equalizing members 63A to 63C are used. However, the outer diameters of the bellow-like seal member 61A and the pressure-equalizing members 63A to 63C may be gradually enlarged in the direction in which the pressure P1 of the seawater acts.

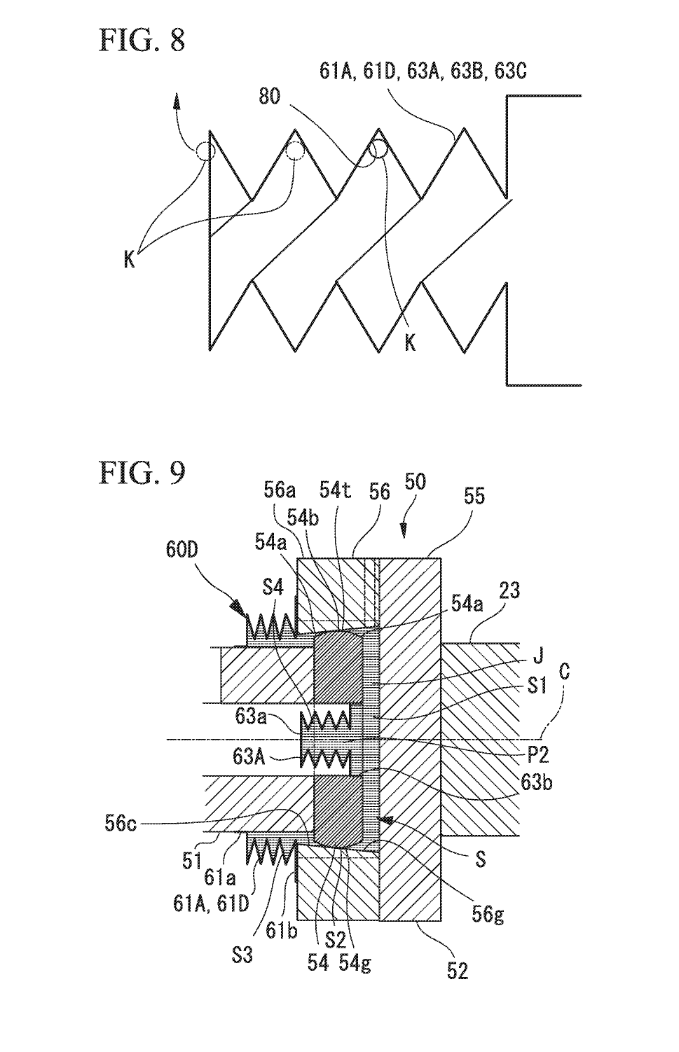

As shown in FIG. 8, the seal members 61A and 61D and the pressure-equalizing members 63A to 63C may be formed in a shape of bellows, and a groove 80 formed on the inner circumferential surface may be formed in a spiral shape. In the configuration, it is possible to easily discharge bubbles K which remain in the groove 80 when injecting the lubricant J by rotating the seal members 61A and 61D and the pressure-equalizing members 63A to 63C around each of the center shafts. Here, the seal members 61A and 61D and the pressure-equalizing members 63A to 63C are rotated such that the bubbles K move to the injection port 66 side along the groove 80. Accordingly, it is possible to guide the bubbles K discharged from the seal members 61A and 61D and the pressure-equalizing members 63A to 63C to the injection port 66, and to discharge the bubbles to the outside through the injection port 66 (refer to FIG. 3).

In a case where the bubbles K remain, even when the pressure-equalizing members 63A to 63C and the seal member 61D contract due to the pressure P1 of the seawater, the bubbles having lower density than that of the lubricant J are broken, and thus, the pressure P2 of the lubricant J does not efficiently increase. However, by discharging the bubbles K as described above, it is possible to efficiently equalize the pressure P1 of the seawater and the pressure P2 of the lubricant J.

Furthermore, as shown in FIG. 9, the seal members 61A and 61D having the spiral groove 80 may be mounted on the outer sleeve 56 having a tapered inner circumferential surface 56c. By doing so, it is possible to allow the bubbles escaped from the seal members 61A and 61D to smoothly pass through the meshing portion S2, and to move the bubbles to the injection port 66 side. Therefore, it is possible to further reduce residuals of the bubbles K.

In each of the above-described embodiments and in each of the modification examples, a case where the water flow power generator 10 is installed in the deep sea is described, but the installation place is not limited to the deep sea.

When the number of blades 22 of the impeller 20 is a plural number, the number is not limited to the above-described number.

In addition to this, for example, as configurations of each portion of the water flow power generator 10, other appropriate configurations can be employed.

### INDUSTRIAL APPLICABILITY

The invention can be employed in the underwater coupling joint and the water flow power generator. The underwater coupling joint and the water flow power generator in which the invention is employed can maintain a lubricated state in the underwater coupling joint and suppress a load applied to maintenance.

### REFERENCE SIGNS LIST

10 Water Flow Power Generator

20 Impeller

21 Hub

21a Tip End

21b End Surface

21c Tubular Portion

22 Blade

22a Base End Portion

22b Tip End Portion

23 Shaft (Rotational Shaft)

30 Nacelle

31 Casing

31a First End Portion

31b Second End Portion

32 Power Generator

32a Input Shaft

33 Main Shaft

33a First End Portion

33b Second End Portion

34 Impeller Support Portion

35 External Bearing

36 Partition Wall

36h Shaft Hole

37 Power Generator Chamber

38 Seal Member

50 Coupling Joint (Underwater Coupling Joint)

51 Center Tube (Second Shaft Member)

51F Outer Circumferential Surface

52 Joint Member (First Shaft Member)

54 Inner Gear

54a End Portion

54b Center Portion

54g Gear Teeth

54t Gear Surface

55 Joint Plate

56 Outer Sleeve

56a Outer Circumferential Surface

56b Inner Circumferential Surface

56g Gear Teeth (First Gear Teeth)

56v Inner Circumferential Surface

60A, 60B, 60C, 60D Seal Portion

61A, 61D Seal Member

61a First End Portion

61b Second End Portion

62A, 62B, 62C External Pressure Introduction Portion

63A, 63B, 63C, 63D Pressure-Equalizing Member (Pressure-Equalizing Mechanism)

63a First End Portion

63b Second End Portion

64A, 64B, 64C Seawater Introduction Portion

65A, 65B Introduction Hole

65a First End Portion

65b Second End Portion

66 Injection Port

67 Cap

70 Pressure Receiving Surface

80 Groove

J Lubricant

P1 Pressure of Seawater

P2 Pressure of Lubricant

S Lubricated Space (Space)

S1 Void

S2 Meshing Portion

S3 Space

S4 Space

S5 Lubricated Space

1. An underwater coupling joint comprising:
a first shaft member which has first gear teeth;
a second shaft member which has second gear teeth meshing with the first gear teeth, and through which a rotational force is transmitted between the first shaft members via the first gear teeth and the second gear teeth;
a seal member which blocks a space including a meshing portion of the first gear teeth and the second gear teeth from the outside between the first shaft members and the second shaft member;
a lubricant which fills the space; and
a pressure-equalizing mechanism which is provided to face a part of the space, changes a volume of the space by deforming in accordance with a pressure of the outside, and thereby equalizes a pressure of the lubricant and the pressure of the outside.

2. The underwater coupling joint according to claim 1,
wherein the pressure-equalizing mechanism is bellows of which a first end portion is open, a second end portion has a blocked tubular shape, and the first end portion and the second end portion are capable of extending and contracting in a direction of being in contact with and separated from each other.

3. The underwater coupling joint according to claim 2,
wherein the bellows has a spiral groove at least on an inner circumferential surface.

4. The underwater coupling joint according to claim 1,
wherein an external pressure introduction portion which introduces the pressure of the outside to one of the first shaft member and the second shaft member is provided, and
wherein the external pressure introduction portion includes the pressure-equalizing mechanism.

5. The underwater coupling joint according to claim 1,
wherein an injection port through which the lubricant is injected from the outside into the space is provided in one of the first shaft member and the second shaft member, and
wherein the injection port includes the pressure-equalizing mechanism.

6. The underwater coupling joint according to claim 1,
wherein the seal member is formed to be deformable in accordance with the pressure of the outside, and functions as the pressure-equalizing mechanism.

7. The underwater coupling joint according to claim 1,
wherein the seal member is bonded to the first shaft member and the second shaft member.

8. A water flow power generator comprising:
an impeller having a plurality of blades;
a power generator which is driven by the impeller; and
the underwater coupling joint according to claim 1 which links a rotational shaft of the impeller and an input shaft of the power generator.
